(19) United States
(12) Patent Application Publication
(10) Pub. No.: US 2015/0167606 A1
(43) Pub. Date: Jun. 18, 2015

(54) METHOD AND APPARATUS FOR CONTROLLING HEATING OF FUEL FILTER

(71) Applicant: Hyundai Motor Company, Seoul (KR)

(72) Inventors: Su Young PARK, Uiwang-si (KR); Tae Young KIM, Gunpo-si (KR)

(73) Assignee: Hyundai Motor Company, Seoul (KR)

(21) Appl. No.: 14/457,983

(22) Filed: Aug. 12, 2014

(30) Foreign Application Priority Data
Dec. 13, 2013 (KR) 10-2013-0155753

(51) Int. Cl. F02M 37/22; B01D 35/00; B01D 35/18

(52) U.S. Cl. CPC F02M 37/223; B01D 35/18; B01D 35/005

(57) ABSTRACT

Disclosed are a method and an apparatus for controlling heating of a fuel filter. The method may include a first step of measuring a temperature of intake air that enters an engine, a second step of measuring a temperature of cooling water, and a third step of, upon input of a key-on signal, controlling whether to activate or deactivate a heater for the fuel filter in response to the measured temperatures of the intake air and the cooling water.

### CROSS REFERENCE TO RELATED APPLICATION

The present application claims priority of Korean Patent Application Number 10-2013-0155753 filed on Dec. 13, 2013, the entire contents of which application are incorporated herein for all purposes by this reference.

### BACKGROUND OF INVENTION

1. Field of Invention

The present invention relates, in general, to a technique to control heating of a fuel filter and, more particularly, to a method and apparatus for controlling heating of a fuel filter, which realize a heating logic for the fuel filter, using a temperature sensor capable of reflecting an external environment and a driving state of a vehicle, rather than a fuel temperature sensor in the fuel filter.

2. Description of Related Art

Generally, in a cold environment such as in winter, in a fuel filter for a vehicle, fuel may be subjected to solidification due to cold air thus clogging the fuel filter, thereby causing start failure or engine stopping. Thus, it is required to perform a control action to heat the fuel filter in order to prevent such a problem.

A conventional solution is such that a thermostat is provided in the fuel filter so that a heater operates in response to temperature. However, if the thermostat is out of order or malfunctions, there is a problem of start performance such as start failure or engine stopping.

To solve this problem, a configuration is contemplated such that a temperature sensor is disposed in a fuel filter so that a controller controls a heater to operate based on the temperature detected by the temperature sensor. That is, the temperature of fuel passing through the fuel filter is directly detected so that the heater is controlled to selectively operate according to the detected temperature of fuel.

However, in case the temperature sensor fails to operate and heating control on the fuel filter is interrupted particularly when ambient temperature is low, at the fuel filter, fuel solids are created to clog the fuel filter, causing an engine stop when a vehicle is traveling, resulting in a traffic accident.

Thus, in case the temperature sensor for fuel fails, it is required to continuously operate the heater to prevent the above problem. In this case, however, even when the temperature of fuel approaches room temperature, a main filter (300 W) and a free filter (400 W) still consume power to cause a power shortage in a battery, thereby making it difficult to perform re-start.

In the meantime, a heating device for a fuel filter in a diesel engine is disclosed in Korean Unexamined Patent Publication No. 10-2012-013694. However, the disclosed heating device has a problem in that upon re-start after a vehicle is driven, the fuel filter is still heated by logic even when it is not required to heat the fuel filter.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art and/or other problems, and the present invention is intended to provide a method and an apparatus for controlling heating of a fuel filter, which realize a heating logic for the fuel filter, using a temperature sensor capable of reflecting an external environment and a driving state of a vehicle, rather than a fuel temperature sensor in the fuel filter. In addition, the present invention is directed to provide a method and an apparatus for controlling heating of a fuel filter which, in a vehicle having a temperature sensor for fuel, is able to heat fuel when the temperature sensor for fuel and a heating switch fail to operate.

In various aspects, the present invention provides a method of controlling heating of a fuel filter, the method including: a first step of measuring a temperature of intake air that enters an engine, a second step of measuring a temperature of cooling water, and a third step of, upon input of a key-on signal, controlling whether to activate or deactivate a heater for the fuel filter in response to the measured temperatures of the intake air and the cooling water.

The third step may be carried out such that, if the temperature of the intake air is not more than a first reference value and the temperature of the cooling water is not more than a second reference value, the heater is activated. The third step may be carried out such that, if the temperature of the intake air is not more than a first reference value, the heater is activated or deactivated in response to the temperature of the cooling water. The third step may be carried out such that, if the temperature of the cooling water is not more than a second reference value, the heater is activated, and if the temperature of the cooling water exceeds the second reference value, the heater is deactivated.

The third step may be carried out such that, if the temperature of the intake air exceeds a first reference value and the temperature of the cooling water exceeds a second reference value, the heater is deactivated. The third step may be carried out such that, if a key-off signal is input, the heater for a fuel filter is deactivated.

The method may further include a fourth step of determining a failure state of a temperature sensor for fuel or a heater switch, which is mounted in the fuel filter. The fourth step may include: measuring the temperature of the fuel by the temperature sensor, obtaining a temperature of the fuel based on the temperatures of the intake air and the cooling water from a learning map that shows a correlation of the temperature of the fuel with the temperatures of the intake air and the cooling water, and determining that the failure state is occurred if the measured temperature of the fuel measured by the temperature sensor is different from the temperature of the fuel obtained from the learning map by a predetermined reference range or more.

In some aspects, the present invention provides a method of controlling heating of a fuel filter, the method including: a first step of measuring a temperature of cooling water, and a second step of controlling an operation of a heater such that, upon input of a key-on signal, if the measured temperature of the cooling water is not more than a second reference value, the heater is activated, and if the measured temperature of the cooling water exceeds the second reference value, the heater is deactivated.

In various other aspects, the present invention provides an apparatus for controlling heating of a fuel filter, the apparatus including: a first temperature sensor provided on an intake line of an engine to measure a temperature of intake air entering the engine, a second temperature sensor provided on a cooling water line to measure a temperature of cooling water, and a controller to which a key-on signal and a key-off signal are input and which is configured to, upon input of the key-on signal, control a heater for the fuel filter to be activated or deactivated in response to the measured temperatures of the intake air and the cooling water.

The controller may be connected with the first and second temperature sensors, and the controller may be connected with a relay on a circuit line for supplying power to the heater such that the controller is able to control a switching operation of the relay.

According to the present invention, since the temperature sensor for intake air and/or cooling water is used, instead of a temperature sensor for fuel, in order to determine whether to heat the fuel filter, the temperature sensor for fuel can be removed in a vehicle, thereby contributing to reduced cost and weight for a vehicle.

Further, heating of the fuel filter is controlled by precisely determining a decrease in temperature of fuel, taking account of the temperature of cooling water reflecting a cooling state of an engine, providing the effect of improving reliability and accuracy of a heating control logic.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram illustrating an exemplary apparatus for controlling heating of a fuel filter according to the present invention;

FIG. 2 is a flow chart illustrating an exemplary method of controlling heating of a fuel filter according to the present invention;

FIG. 3 is a flow chart illustrating another exemplary method of controlling heating of a fuel filter according to the present invention; and

FIG. 4 is a flow chart illustrating still another exemplary method of controlling heating of a fuel filter according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

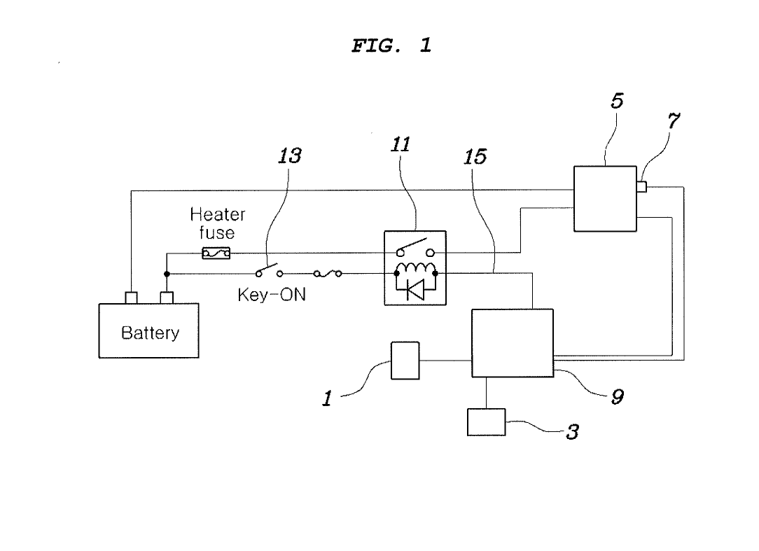

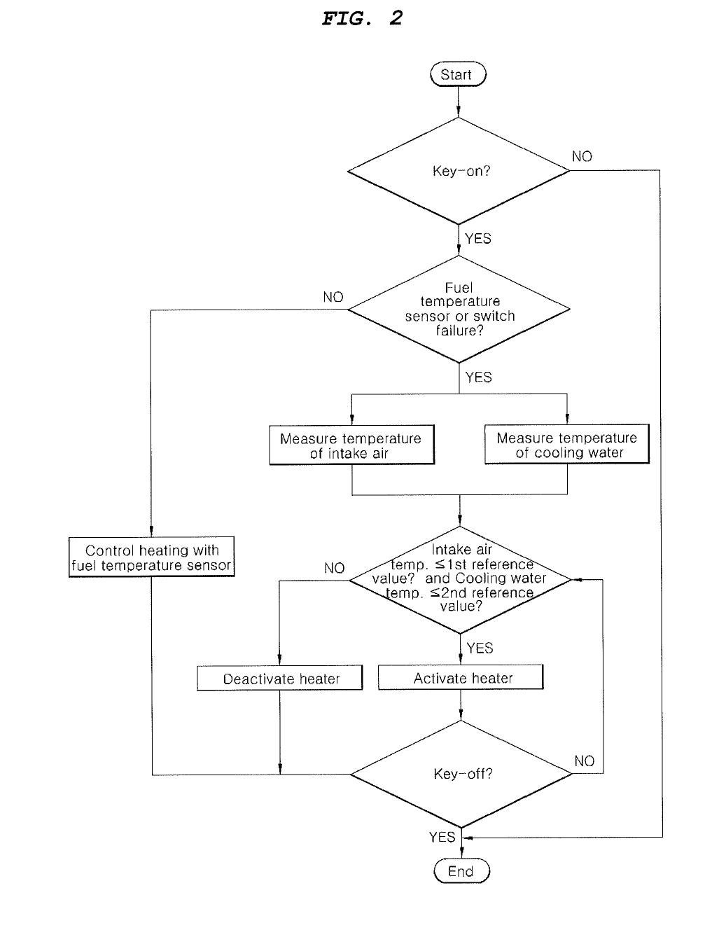

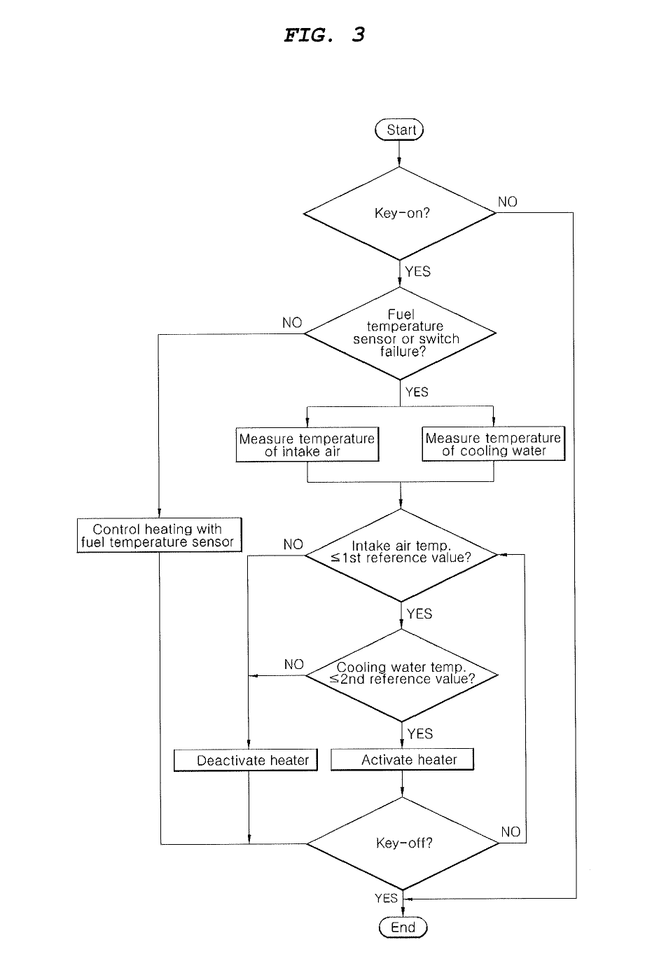

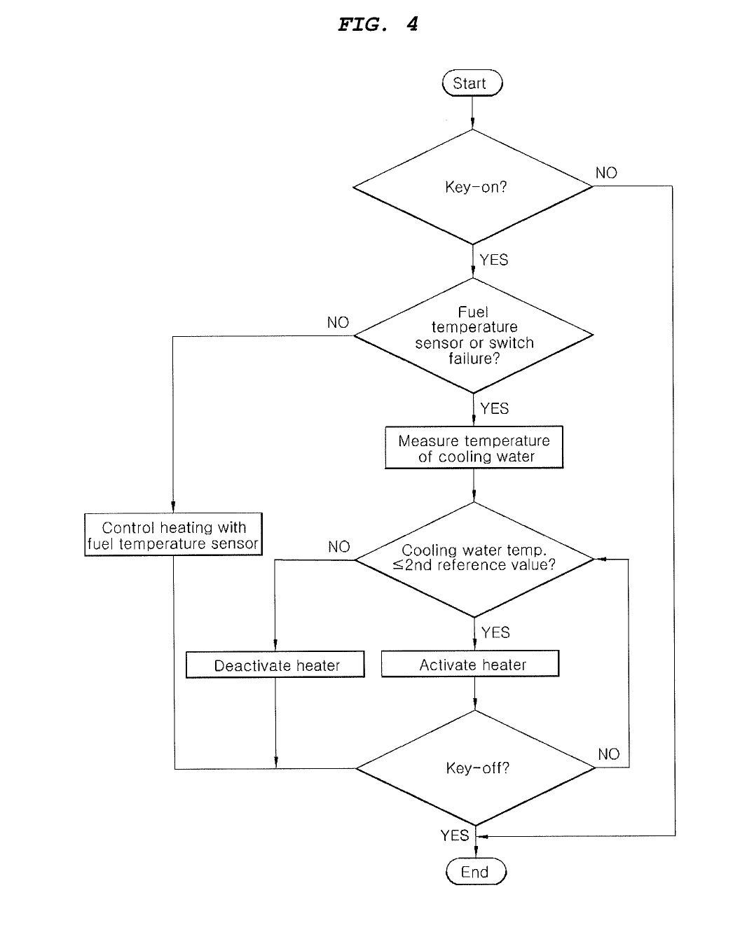

FIG. 1 is a block diagram of an apparatus for controlling heating of a fuel filter according to various embodiments of the present invention, FIG. 2 is a flow chart of a method of controlling heating of a fuel filter according to a first embodiment of the present invention, FIG. 3 is a flow chart of a method of controlling heating of a fuel filter according to a second embodiment of the present invention, and FIG. 4 is a flow chart of a method of controlling heating of a fuel filter according to a third embodiment of the present invention.

The heating control apparatus for a fuel filter generally includes a temperature sensor 1 for intake air, a temperature sensor 3 for cooling water, and a controller 9.

Specifically, referring to FIG. 1, the apparatus includes a first temperature sensor 1 which is provided on an intake line of an engine so as to measure temperature of intake air entering the engine, a second temperature sensor 3 which is provided on a cooling water line so as to measure temperature of cooling water, and a controller 9 to which a key-on signal and a key-off signal are input and which is configured to, upon input of the key-on signal, control a heater for a fuel filter 5 to be activated or deactivated in response to measured temperatures of intake air and cooling water.

The first temperature sensor 1 for intake air may use a mass airflow (MAF) sensor, and the temperature of intake air detected by the first temperature sensor 1 may corresponds to atmosphere temperature or the temperature within a margin of error from the atmosphere temperature. The heater may be a positive temperature coefficient (PTC) heater mounted in a fuel filter.

The controller 9 may be an electronic control unit (ECU) which is electrically connected with the first temperature sensor 1 for intake air and the second temperature sensor 3 for cooling water so that the controller can receive the detected temperatures of intake air and cooling water. The controller 9 may be connected with a relay 11 on a circuit line 15 for supplying power to the heater such that the controller is able to control a switching operation of the relay 11.

That is, upon key-on, a relay-energizing switch 13 provided on the circuit line 15 switches to an on-state so as to supply current for connection of the relay 11, and at the same time, the controller 9 compares the temperature of intake air and the temperature of cooling water with reference values.

Then, when it is determined that the temperature of intake air and the temperature of cooling water do not satisfy heater operation conditions, the controller 9 controls the relay 11 to switch to an off-state that the relay 11 is not connected. On the contrary, when it is determined that the temperature of intake air and the temperature of cooling water satisfy heater operation conditions, the controller 9 controls the relay 11 to switch to an on-state that the relay 11 is connected, so that the heater is operated to heat fuel in the fuel filter 5.

Like this, the present invention realizes a heating logic for a fuel filter 5 using sensors 1 and 3 for detecting the temperature of intake air and the temperature of cooling water, which are mounted in a vehicle, instead of a fuel temperature sensor 7 in a fuel filter 5, thereby eliminating the fuel temperature sensor 7 and therefore reducing cost and weight.

In another aspect, the present invention provides a method of controlling heating of a fuel filter, which generally includes a step of measuring temperature of intake air, a step of measuring temperature of cooling water, and a heating control step.

Referring to FIGS. 1 to 4, specifically, the method includes: measuring the temperature of intake air sucked into an engine; measuring the temperature of cooling water; and, upon input of a key-on signal, controlling whether to activate or deactivate the heater of the fuel filter 5 according to the measured temperatures of intake air and cooling water.

That is, according to the present invention, as a temperature sensor for determining whether to heat the fuel filter 5, existing temperature sensors 1 and 3 for intake air and cooling water, which are mounted in a vehicle, are used, instead of the fuel temperature sensor 7 which is mounted in the fuel filter 5, so that the fuel temperature sensor 7 can be removed, thereby reducing cost and weight of a vehicle.

Referring to FIG. 2, in the heating control step according to a first embodiment, when the temperature of intake air is equal to or less than a first reference value, and the temperature of cooling water is equal to or less than a second reference value, the heater is controlled to be activated.

That is, since the temperature of intake air and the temperature of cooling water are used instead of the fuel temperature, if the temperature of intake air and the temperature of cooling water are measured to be predetermined reference values or less, the heater is controlled to be activated.

Referring to FIG. 3, in the heating control step according to a second embodiment, when the temperature of intake air is measured to be a first reference value or less, the heater is controlled to be activated or deactivated according to the temperature of cooling water.

Specifically, the heater is controlled to be activated or deactivated when the temperature of cooling water is measured to be a second reference value or less, or above a second reference value, respectively.

That is, in a case where a predetermined time after an engine stop has elapsed before an engine re-start, if an engine-stop time is long, actually fuel is cooled. However, if the engine-stop time is short, actually fuel is in a still-heated state, maintaining a relatively high temperature that does not require heating by a heater.

That is, although it is determined that heating by a heater is required when the temperature of intake air is measured to be a first reference value or less due to both low temperature of cool ambient air and a seasonal factor, since actually the temperature of fuel in the fuel filter 5 may be the temperature that does not require heating, the temperature of fuel is precisely determined by additionally considering the temperature of cooling water that reflected the cooling step of an engine.

Thus, in the condition of the temperature of intake air being measured to be a first reference value or less, when the temperature of cooling water is measured to be a second reference value or less, a heater is controlled to be activated, and when the temperature of cooling water is measured to be over the second reference value, the heater is controlled to be deactivated, thereby improving reliability and precision of a heating control logic.

In the heating control step according to the first and second embodiments, when the temperature of intake air exceeds the first reference value and the temperature of cooling water exceeds the second reference value, the heater may be controlled to be deactivated.

Further, according to the present invention, the heater of the fuel filter 5 may be controlled to be deactivated when a key-off signal is input.

That is, upon input of a key-on signal to a vehicle, a heater is activated when the state satisfies temperature conditions on intake air and cooling water. This control should be continuously performed when a vehicle is traveling.

However, when a vehicle stops and a key-off signal is input, the vehicle is not in a traveling state, so the heater can be deactivated.

The present invention may further include determining a failure state of the temperature sensor 7 for fuel or a heater switch, which is mounted in the fuel filter 5.

That is, according to the present invention, a temperature sensor 7 for fuel, which is provided in a fuel filter 5, can be removed, so a heating control logic is realized using temperature sensors 1 and 3 for intake air and cooling water, instead of the temperature sensor 7. However, in a state where the temperature sensor 7 for fuel has been mounted in the fuel filter 5, if the temperature sensor 7 for fuel or a heater switch is out of order, the heating control step may be performed so that the heating control logic is carried out using the temperature sensors 1 and 3 for intake air and cooling water, instead of the temperature sensor 7 for fuel.

Here, the heater switch may be a relay 11 or a relay-energizing switch 13, which is mounted on the circuit line 15, so a failure of the switch can be determined.

Specifically, the failure-state determination step may include: by the temperature sensor 7 for fuel, measuring temperature of fuel; and determining the failure state using a learning map showing a correlation of the temperature of fuel with the temperatures of intake air and cooling water, when the measured temperature of fuel measured by the temperature sensor 7 is different from the temperature of fuel shown in the learning map by a predetermined reference range or more. Therefore, a failure of the temperature sensor 7 for fuel or the relay 11 or the like is determined so as to diagnose a malfunction of a heater.

In the meantime, referring to FIG. 4, a heating control method according to a third embodiment includes: a first step of measuring temperature of cooling water; and a second step of controlling an operation of a heater such that, upon input of a key-on signal, when the measured temperature of cooling water is not more than a second reference value, the heater is activated, and when the measured temperature of cooling water exceeds the second reference value, the heater is deactivated.

According to this embodiment, ambient temperature of a vehicle can be expected using the temperature of cooling water, and upon re-start of an engine after engine-stop, a decrease in temperature of fuel can also be precisely determined using the temperature of cooling water in which a cooled state of an engine has been reflected, so that whether to activate or deactivate a heater can be determined according to the temperature of cooling water.

Here, the third embodiment can also realize a heating control logic that is performed in a system in which a temperature sensor 7 for fuel is removed, or in which, although the temperature sensor 7 for fuel is installed, the temperature sensor 7 is out of order, in which latter system the heating control logic is performed using other temperature sensors for intake air and cooling water, rather than the temperature sensor 7 for fuel.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling heating of a fuel filter, the method comprising:
a first step of measuring a temperature of intake air that enters an engine;
a second step of measuring a temperature of cooling water; and
a third step of, upon input of a key-on signal, controlling whether to activate or deactivate a heater for the fuel filter in response to the measured temperatures of the intake air and the cooling water.

2. The method according to claim 1, wherein the third step is carried out such that, if the temperature of the intake air is not more than a first reference value and the temperature of the cooling water is not more than a second reference value, the heater is activated.

3. The method according to claim 1, wherein the third step is carried out such that, if the temperature of the intake air is not more than a first reference value, the heater is activated or deactivated in response to the temperature of the cooling water.

4. The method according to claim 3, wherein the third step is carried out such that, if the temperature of the cooling water is not more than a second reference value, the heater is activated, and if the temperature of the cooling water exceeds the second reference value, the heater is deactivated.

5. The method according to claim 1, wherein the third step is carried out such that, if the temperature of the intake air exceeds a first reference value and the temperature of the cooling water exceeds a second reference value, the heater is deactivated.

6. The method according to claim 1, wherein the third step is carried out such that, if a key-off signal is input, the heater for a fuel filter is deactivated.

7. The method according to claim 1, further comprising:
a fourth step of determining a failure state of a temperature sensor for fuel or a heater switch, which is mounted in the fuel filter.

8. The method according to claim 7, wherein the fourth step comprises:
measuring the temperature of the fuel by the temperature sensor;
obtaining a temperature of the fuel based on the temperatures of the intake air and the cooling water from a learning map that shows a correlation of the temperature of the fuel with the temperatures of the intake air and the cooling water; and
determining that the failure state is occurred if the measured temperature of the fuel measured by the temperature sensor is different from the temperature of the fuel obtained from the learning map by a predetermined reference range or more.

9. A method of controlling heating of a fuel filter, the method comprising:
a first step of measuring a temperature of cooling water; and
a second step of controlling an operation of a heater such that, upon input of a key-on signal, if the measured temperature of the cooling water is not more than a second reference value, the heater is activated, and if the measured temperature of the cooling water exceeds the second reference value, the heater is deactivated.

10. An apparatus for controlling heating of a fuel filter, the apparatus comprising:
a first temperature sensor provided on an intake line of an engine to measure a temperature of intake air entering the engine;
a second temperature sensor provided on a cooling water line to measure a temperature of cooling water; and
a controller to which a key-on signal and a key-off signal are input and which is configured to, upon input of the key-on signal, control a heater for the fuel filter to be activated or deactivated in response to the measured temperatures of the intake air and the cooling water.

11. The apparatus according to claim 10, wherein the controller is connected with the first and second temperature sensors, and the controller is connected with a relay on a circuit line for supplying power to the heater such that the controller is able to control a switching operation of the relay.
